(19) United States
(12) Patent Application Publication
(10) Pub. No.: US 2003/0175516 A1
(43) Pub. Date: Sep. 18, 2003

(54) Porcelain oven rack

(75) Inventor: David James Blankenship, Morristown, TN (US)

Correspondence Address: MARSHALL, GERSTEIN & BORUN, 6300 SEARS TOWER, 233 SOUTH WACKER, CHICAGO, IL, 60606-6357, US

(73) Assignee: SSW Holdings Company, Inc., Forth Smith, AR

(21) Appl. No.: 10/384,587

(22) Filed: Mar. 11, 2003

Related U.S. Application Data
(63) Continuation of application No. 10/260,487, filed on Sep. 30, 2002.
(60) Provisional application No. 60/368,501, filed on Mar. 28, 2002.
(60) Provisional application No. 60/364,308, filed on Mar. 14, 2002.

(51) Int. Cl. B32B 9/00; D02G 3/00; B23P 19/04

(52) U.S. Cl. 428/388; 428/364; 29/452; 29/460

(57) ABSTRACT

A porcelain coated steel wire oven rack. The preferred coated steel wire oven rack includes a plurality of elongated steel wire members joined together to form an oven rack having an outer surface. The plurality of elongated steel wire members are made from a steel rod material containing from about 80 to about 99.9% by weight of iron, from about 0.001 to about 0.08% by weight of carbon and from about 0.001 to about 0.2% by weight of a carbon stabilizing transition metal, preferably selected from the group consisting of Vanadium, Tantalum, Titanium and Niobium. The plurality of elongated steel wire members are preferably made from the steel rod material by drawing the steel rod material to form steel wire; wherein the diameter of the cross-sectional area of the steel rod material is reduced by at least about 20% when the steel rod material is drawn to form the steel wire to prevent chipping of the glass material from the outer surface due to the release of hydrogen gas from the steel wire members when the steel wire is heated above 900° F.

### CROSS-REFERENCE TO RELATED APPLICATION

This application is a continuation of application Ser. No. 10/260,487 which claims the benefit of provisional applications Serial No. 60/368,501, filed Mar. 28, 2002, and Serial No. 60/364,308, filed Mar. 14, 2002.

### FIELD OF THE INVENTION

The present invention relates to steel wire products coated with glass material to protect the steel wire products from discoloration and the like due to heating the steel wire products at high temperatures. These steel wire products are preferably oven racks coated with porcelain to provide suitable oven rack surfaces for cooking, which do not discolor during cooking, or during self-cleaning cycles when the oven racks remain in the oven and the temperatures generally exceed the normal cooking temperatures.

### BACKGROUND OF THE INVENTION

Steel wire oven racks made from steel rod drawn to form steel wire are well-known in the industry. Such steel wire oven racks, however, are generally discolored when they are subjected to the high temperatures above 900 degrees F. associated with self-cleaning oven cycles which are common in today's kitchen ovens. It will be appreciated that improvements to address this discoloration problem and to increase color flexibility will be positive additions to the useful arts. The present invention provides such an improvement. It will be appreciated, therefore, that further improvements in oven racks and methods for making oven racks are needed to address problems such as this.

The present invention provides solutions to this and other problems associated with oven racks for ovens sold into consumer markets and otherwise.

### SUMMARY OF THE INVENTION

The present invention provides a coated steel wire oven rack designed to be -received within an oven cavity. The coated steel wire oven rack includes a plurality of elongated steel wire members joined together to form an oven rack having an outer surface; wherein the cross-sectional area of the steel rod material is reduced by at least about 20% when the steel rod material is drawn to form the steel wire; the outer surface of the oven rack being coated by a glass material, the glass material preferably being porcelain, wherein the amount of carbon in the steel rod material, the amount of carbon stabilizing transition metal in the steel rod material and the degree to which the cross-sectional area of the steel rod material is reduced, when the steel wire is drawn from the steel rod material is balanced so as to prevent chipping of the glass material away from the outer surface due to the release of hydrogen gas from the steel wire members when the steel wire is either heated or cooled.

In preferred embodiments, the glass material, preferably porcelain, is coated onto the steel wire in two distinct coating steps.

In a preferred embodiment, the coated steel wire oven rack is designed to be received with an oven cavity. The coated steel wire oven rack includes a plurality of elongated steel wire members joined together to form an oven rack having an outer surface. The plurality of elongated steel wire members are made from a steel rod material containing from about 80 to about 99.9% by weight of iron, from about 0.001 to about 0.08% by weight of carbon, and from about 0.001 to about 0.2% by weight of a carbon stabilizing transition metal selected from the group consisting of Vanadium, Tantalum, Titanium and Niobium. The plurality of elongated steel wire members are made from the steel rod material by drawing the steel rod material to form steel wire; wherein the cross-sectional area of the steel rod material is reduced by at least about 20% when the steel rod material is drawn to form the steel wire. The outer surface of the oven rack is coated by a glass material, preferably porcelain, wherein the amount of carbon in the steel rod material, the amount of carbon stabilizing transition metal in the steel rod material and the degree to which the cross-sectional area of the steel rod material is reduced when the steel wire is drawn from the steel rod material is balanced so as to prevent chipping of the porcelain away from the outer surface due to the release of hydrogen gas from the steel wire material when the steel wire material is either heated or cooled; wherein the porcelain is coated onto the steel in two distinct coating steps wherein the porcelain is coated onto the steel wire in two distinct electrostatic coating processes followed by a single heating process in which the temperature is preferably raised to about 1550° F. In alternate embodiments, the heating process may be repeated and in yet other alternate embodiments, a wet coating process can be used.

The plurality of elongated steel wire members are made from steel rod material containing from about 80 to about 99.9% by weight of iron, from about 0.001 to about 0.08% by weight of carbon and from about 0.001 to about 0.2% by weight of a transition metal which will have a stabilizing effect on the carbon in the elongated steel wire members such that the carbon absorbs less hydrogen gas when the steel wire member is heated to temperatures above 500° F. than it would in the absence of the carbon stabilizing transition metal. In preferred embodiments, the transition metal is selected from the group consisting of Vanadium, Tantalum, Titanium and Niobium, and in the most preferred embodiment, the transition metal is Vanadium. The plurality of elongated steel wire members are preferably made from steel rod material by a process of area reduction. In the preferred process, the steel rod is pulled through a cold die that gradually reduces in diameter so that the rod is drawn repeatedly through the die and the cross-sectional area of the rod is reduced to form a steel wire having a cross-sectional area of diminished diameter. In preferred embodiments, the diameter of the steel wire is diminished at least about 20%, preferably at least about 30%, more preferably at least about 40%, even more preferably at least about 45%, and most preferably at least about 50%. It will be appreciated that the area reduction creates voids in the steel wire which are desirable to provide cavities into which hydrogen gas can release and, perhaps, compress, without creating pressure to be released from the surface of the steel wire once the steel wire is coated with porcelain. It will be appreciated, that the area reduction, which creates cavities in the steel wire, and the inclusion of carbon stabilizing transition metal elements which reduce the degree to which the carbon in the steel absorbs hydrogen, will diminish the degree to which hydrogen gas out-gassing causes cracking and chipping of the porcelain surface of the elongated steel wire members of the oven rack which are coated by the glass material.

The above-described features and advantages along with various advantages and features of novelty are pointed out with particularity in the claims of the present invention which are annexed hereto and form a further part hereof. However, for a better understanding of the invention, its advantages and objects attained by its use, reference should be made to the drawings which form a further part hereof and to the accompanying descriptive matter in which there is illustrated and described preferred embodiments of the preferred invention.

### BRIEF DESCRIPTION OF DRAWINGS

Referring to the drawings, where like numerals refer to like parts throughout the several views:

FIG. 1 is a plan view of a coated oven rack in accord with the present invention;

FIG. 2 is a side view of the oven rack shown in FIG. 1;

FIG. 3 is a cross-sectional view of an outside framing wire 12 as seen from the line 3-3 of FIG. 1;

FIG. 4 is a plan view of an alternate oven rack in accord with the present invention;

FIG. 5 is a side view of the alternate oven rack shown in FIG. 4;

FIG. 6 is a cross-sectional view of an outside framing wire 12′ as seen from the line 6-6 of FIG. 4;

FIG. 7 is a plan view of a further alternate oven rack in accord with the present invention;

FIG. 8 is a side view of the oven rack shown in FIG. 7; and

FIG. 9 is a cross-sectional view of an outside framing wire 12′ as seen from the line 9-9 of FIG. 7.

### DETAILED DESCRIPTION OF THE PREFERRED EMBODIMENT

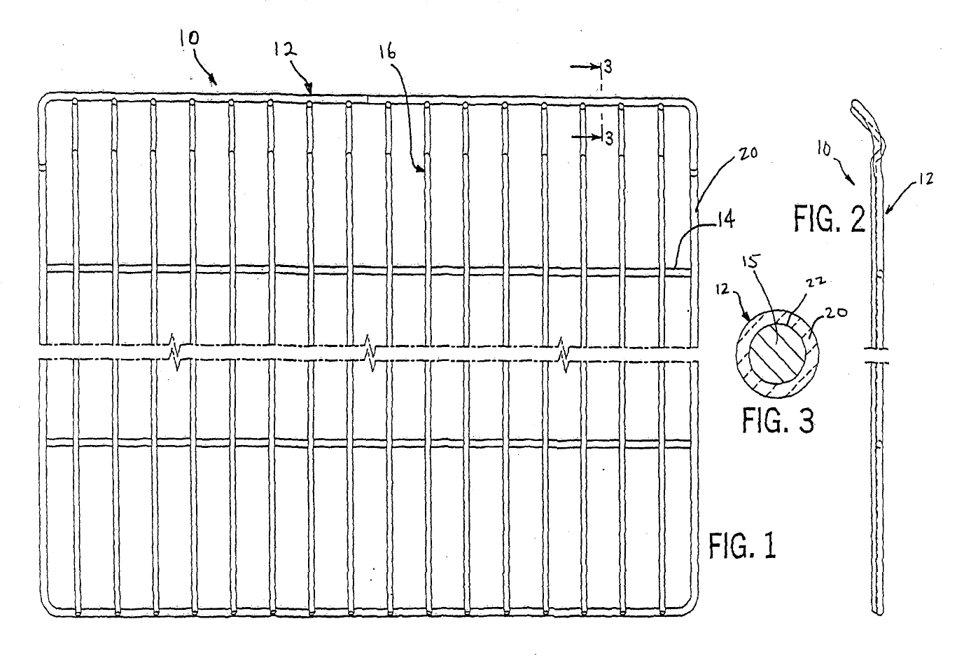

Referring now to the drawings, and in particular FIGS. 1-3, a coated steel wire oven rack 10 is shown. The coated steel oven wire rack 10 has an outside framing wire 12 stabilized by two frame stabilizing support wires 14 and a series of upper surface steel wire members 16 which generally run front to back to provide a support surface for oven utensils (not shown) that are placed on the coated oven rack 10.

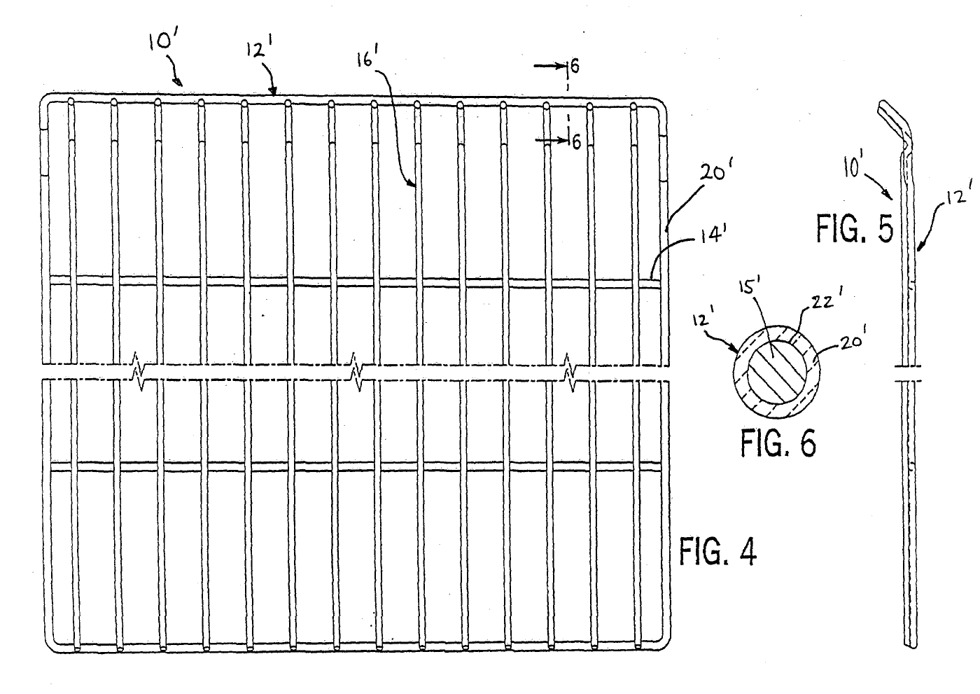

Referring now also to FIGS. 4-6, an alternate oven rack 10′ in accord with the present invention is shown that has only minor differences from the oven rack shown in FIGS. 1-3.

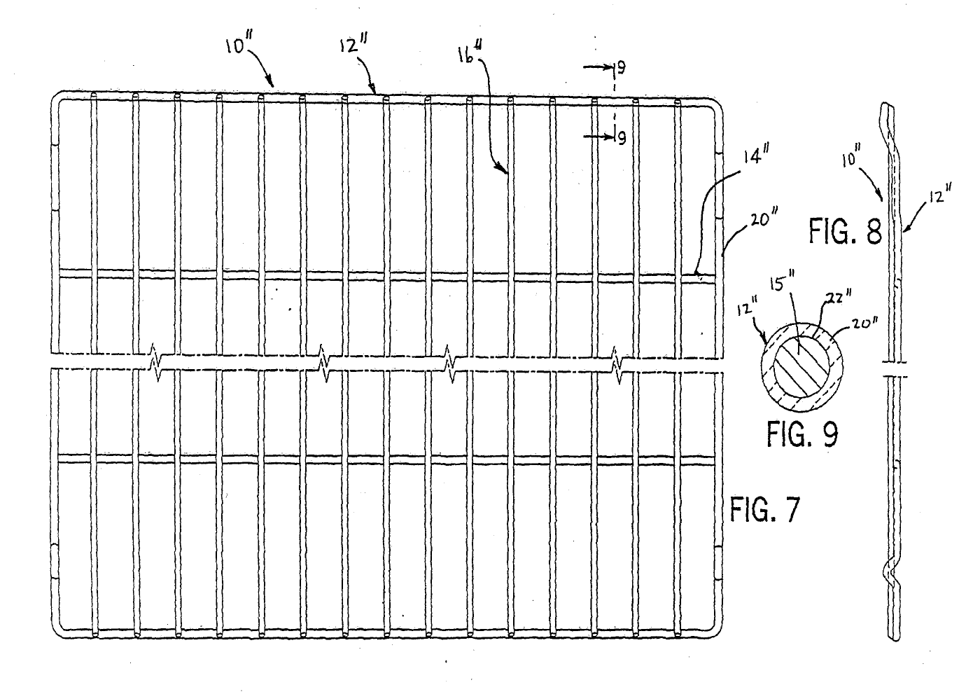

Referring now also to FIGS. 7-9, a further alternate oven rack 10′ in accord with the present invention is shown, having a few other minor differences, but in most other ways being virtually the same as the oven racks shown in FIGS. 1-6.

The present oven rack 10 is coated with a glass material 20, preferably porcelain, which is coated onto the outer surface 22 of welded steel wire parts 15 of the coated oven rack 10, in a process which generally follows these steps. Steel rod material (not shown) is preferably purchased, which is made primarily of iron but includes the elemental composition shown on the following page.

PORCELAIN WIRE SUBSTRATE B SPECIFICATIONS

| | 0.259 Diam. | 0.192 Diam. | 0.239 Diam. |
|---|---|---|---|
| Rod Size | 5/16 | 9/32 | 5/16 |
| Area Reduction | 31% | 53% | 41.50% |
| | Substrate B | | |
| Chemistry | 0.259 Diam. | 0.192 Diam. | 0.239 Diam. |
| Carbon | 0.046% | 0.052% | 0.051% |
| Vanadium | 0.014% | 0.012% | 0.013% |
| Manganese | 0.350% | 0.360% | 0.340% |
| Phosphorus | 0.004% | 0.003% | 0.003% |
| Sulfur | 0.004% | 0.004% | 0.005% |
| Silicon | 0.130% | 0.140% | 0.130% |
| Copper | 0.110% | 0.100% | 0.120% |
| 1″ Sample Size | Substrate B (pre-fire) | | |
| Tensile Testing | 0.259 Diam. | 0.192 Diam. | 0.239 Diam. |
| Yield Strength | 88200 | 100300 | 98600 |
| Ultimate Strength | 89700 | 103400 | 102600 |
| % Elongation in 1″ | 21 | 15 | 20 |
| % Reduction of Area | 71 | 67 | 67 |
| 1″ Sample Size | Substrate B (post-fire) | | |
| Tensile Testing | 0.259 Diam. | 0.192 Diam. | 0.239 Diam. |
| Yield Strength | 57200 | 41400 | 51900 |
| Ultimate Strength | 71700 | 58100 | 70000 |
| % Elongation in 1″ | 40% | 43% | 37 |
| % Reduction of Area | 77% | 80% | 79 |

PEMCO POWDER-1st Coat: GP2025, 2nd Coat: GP1124
Furnace Line Speed: 22 ft/mm (494 hangers/hour), 988 parts/hour
Washer Line Speed: 22 if/mm (494 hangers/hour), 988 parts/hour
4-10 mil thickness
1585F Zone 1 Temp.
1543F Zone 2 Temp.
25 minutes in furnace
10,000 lbs/hr maximum line capacity
Specific Gravity: 2.59
Buffing Process
Scotch-Brite Roloc surface conditioning disc Grade A MED
Disc sprayed with Wesson Liquid Oil

The steel rod is then drawn in an area reduction process, preferably through a cold die, to reduce the diameter of the cross-sectional area, preferably at least about 20%, more preferably at least about 30%, more preferably at least about 35%, even more preferably about 40%, even more preferably about 45%, and most preferably about 50%, in order to incorporate cavities within the steel wire which allow hydrogen to be released into the cavities and also to reduce the diameter of the wire to that which is desired. The sheet on the following page gives the general specifications for non-iron elements and other aspects of the steel wire and the steel rod used to make the steel wire.

Once the steel rod is converted into wire in the wire drawing process, the steel wire is straight cut to predetermined lengths according to need. The various cut steel wire members are then formed as needed to provide the various parts of the coated oven rack. These parts are then welded together to form an oven rack substrate (not shown), for subsequent coating, in a standard welding operation. The oven racks are then cleaned in a washing process and then power acid washed with an electrically charged acid wash material to remove any remaining weld scale. The rack is then dried in an oven at about 500° F. and then air cooled. The clean oven rack is then sprayed with powdered glass in an electrostatic charged paint process in which the oven rack substrate-is charged negatively and the glass powder is charged positively.

The spraying process is divided into a first coating process in which a first coat or a ground coat is placed upon the oven rack substrate. In preferred embodiments the first coat is a Pemco powder, GP2025 from Pemco. It will be appreciated that other similar or equivalent powders may also be used in alternate embodiments. After the first coat is applied a second coat or a top coat is applied. In preferred embodiments, this coat is a Pemco powder, GP1124, from Pemco. Again, it will be appreciated that other similar or equivalent powders may also be used in alternate embodiments. The coated oven rack substrate is then heated in an oven to about 1550° F. for about 25 minutes and then cooled. This coating and baking process is generally referred to as a double coat, single fire coating process. The coated oven racks are then cooled, buffed, preferably with a Scotch-Bright Robe surface conditioning disc grade A medium, sprayed with liquid oil, preferably Wesson liquid oil, and then packaged for shipping to the customer.

In an alternate process, the oven rack substrate is coated using a wet spray process, wherein the porcelain is coated onto the steel wire, in number of steps selected from each of five distinct wet coating processes including wet spray, electrostatic wet spray, wet flow coating, wet dip or electrophoretic deposition, or, more specific, as applied to porcelain, “EPE-Electro-porcelain enameling.” This later process involves the use of a dip system where electric power is used to deposit porcelain enamel material on a metal surface. The wet coating processes can be single step, double step or multiple step processes followed by at least single or double heating process steps m which the temperature is preferably raised to about 1550 degrees F. or greater. In these processes, porcelain can be coated to steel by three basic methods of wet spraying by air atomization, hand spraying, automatic spraying and electrostatic spraying. When substrate is processed through a dipping operation, the part is immersed in the “slip”, removed, and the slip is allowed to drain off. In flow coating, the slip is flowed over the part and the excess is allowed to drain off. Carefully controlled density of the porcelain enamel slip and proper positioning of the part is necessary to produce a uniform coating by dip or flow coat methods. Porcelain can be coated to steel by immersion or flow coating, as well, by five basic methods, hand dipping, tong dipping, automatic dip machines or systems, electrophoretic deposition systems and flow coating. It will be appreciated that any number of these various methods may be adapted for use within the broad general scope of the present invention.

It is to be understood, however, that even though numerous characteristics and advantages of the various embodiments of the present invention have been set forth in the foregoing description, together with details of the structure and function of the various embodiments of the present invention as shown in the attached drawings, this disclosure is illustrative only and changes may be made in detail, especially in manners of shape, size and arrangement of the parts, within the principles of the present invention, to the full extent indicated by the broad general meaning of the terms in which the appended claims are expressed.

What is claimed is:

1. A glass-coated, drawn steel rod article capable of withstanding a hydrogen-emitting temperature sufficient to emit hydrogen gas from the steel such that hydrogent gas emitted from the steel is contained within cavities formed in the steel during drawing, without escaping through the glass coating, such that the glass coating does not chip or crack at said hydrogen-emitting temperature, wherein the steel rod is drawn to reduce the diameter of the steel rod at least 20%, and the steel comprises the following components by weight:

| | |
|---|---|
| Iron | about 80% to about 99.9%; |
| Carbon | about 0.001% to about 0.08%; and |
| A transition metal selected | 0.001% to about 0.2%. |
| from Vn, Ta, Ti, Ni or | |
| mixture of any two or more | |

2. The glass coated, drawn steel rod article of claim 1, wherein the amounts of iron, carbon, and transition metal and the degree of diameter reduction of the steel rod are selected to provide sufficient cavities in the drawn steel such that the glass coating does not chip or crack when the glass-coated article is heated to a temperature above 900° F.

3. The glass-coated, drawn steel rod article of claim 2, wherein the glass coating is a porcelain material applied in a thickness is the range of 4 to 10 mils.

4. The glass-coated, drawn steel product of claim 1, wherein the article is a cooking surface selected from an oven rack and a barbeque grill rack.

5. The glass-coated, drawn steel article of claim 3, wherein the glass coating is a porcelain enamel material.

6. The glass-coated, drawn steel article of claim 5, wherein the porcelain is applied in multiple coating steps.

7. The glass-coated, drawn steel article of claim 1, wherein the steel rod is drawn to reduce the diameter of the steel rod at least about 30%.

8. The glass-coated, drawn steel article of claim 7, wherein the steel rod is drawn to reduce the diameter of the steel rod at least about 40%.

9. The glass-coated, drawn steel article of claim 8, wherein the steel rod is drawn to reduce the diameter of the steel rod at least about 45%.

10. The glass-coated, drawn steel article of claim 9, wherein the steel rod is drawn to reduce the diameter of the steel rod at least about 50%.

11. The glass-coated, drawn steel article of claim 1, wherein the steel rod is drawn repeatedly through a cold die to gradually reduce the rod diameter.

12. The glass-coated, drawn steel article of claim 1, wherein the steel rod is drawn in a cold die to provide sufficient cavities in the drawn steel for receiving hydrogen emitted from the drawn steel such that the glass coating is not damaged by the emitted hydrogen when the article is heated to a temperature above 900° F.

13. A drawn steel rod article, cold drawn to reduce its diameter by at least 20%, formed from steel rod having a composition by weight comprising: iron: about 80% to about 99.9%; carbon: about 0.001% to about 0.08%; and a transition metal selected from the group consisting of Vn, Ta, Ti, and Ni: about 0.01% to about 0.2%, said drawn steel article containing sufficient cavities to receive hydrogen emitted from the steel at a temperature above 900° F. to prevent the emitted hydrogen from escaping through a porcelain coating when the drawn steel rod material, after being coated with the porcelain, is heated above 900° F.

14. The drawn steel rod article of claim 13, wherein the amounts of iron, carbon, and transition metal and the degree of diameter reduction of the steel rod during cold drawing are selected to provide sufficient cavities in the drawn steel such that the porcelain coating does not chip or crack when the article is subsequently coated with porcelain and then heated to a temperature above 900° F.

15. The drawn steel rod article of claim 13, wherein the article is a cooking surface selected from an oven rack and a barbeque grill rack.

16. The drawn steel rod article of claim 13, wherein the steel rod is drawn to reduce the diameter of the steel rod at least about 30%.

17. The drawn steel rod article of claim 16, wherein the steel rod is drawn to reduce the diameter of the steel rod at least about 40%.

18. The drawn steel rod article of claim 17, wherein the steel rod is drawn to reduce the diameter of the steel rod at least about 45%.

19. The drawn steel rod article of claim 18, wherein the steel rod is drawn to reduce the diameter of the steel rod at least about 50%.

20. The drawn steel rod article of claim 13, wherein the steel rod is drawn repeatedly through a cold die to gradually reduce the rod diameter.

21. A coated steel wire article comprising:
a plurality of elongated steel wire members joined together to form an oven rack having an outer surface;
the plurality of elongated steel wire members being made from a steel rod material containing from about 80 to about 99.9% by weight of iron, from about 0.001 to about 0.08% by weight of carbon and from about 0.001 to about 0.2% by weight of a carbon stabilizing transition metal selected from the group consisting of Vanadium, Tantalum, Titanium and Niobium;
the plurality of elongated steel wire members being made from the steel rod material by drawing the steel rod material to form steel wire;
wherein the diameter of the cross-sectional area of the steel rod material is reduced by at least about 20% when the steel rod material is drawn to form the steel wire;
the outer surface of the oven rack being coated by a glass material;
wherein the amount of carbon in the steel road material, the amount of carbon stabilizing transition metal in the steel rod material and the degree to which the diameter of the cross-sectional area of the steel rod material is reduced, when the steel wire is drawn from the steel rod material, are selected to prevent chipping of the glass material away from the outer surface of the article due to the release of hydrogen gas from the steel wire members when the glass-coated steel wire members are heated to a temperature above 900° F.

22. The coated steel wire oven rack of claim 21, wherein the glass material is porcelain coated onto the outer surface of the steel wire members by first applying a ground coat and thereafter applying a top coat.

23. The coated steel wire oven rack of claim 22, wherein the coating thickness is in the range of 4 to 10 mils.

24. The coated steel wire oven rack of claim 23, wherein the coated porcelain comprises porcelain enamel.

25. A coated steel wire oven rack designed to be received within an oven cavity, the coated steel wire oven rack comprising:
a plurality of elongated steel wire members joined together to form an oven rack shape having an outer surface;
the plurality of elongated steel wire members being made from a steel rod material containing from about 80 to about 99.9% by weight of iron, from about 0.001 to about 0.08% by weight of carbon and from about 0.001 to about 0.02% by weight of a carbon stabilizing transition metal selected from the group consisting of Vanadium, Tantalum, Titanium and Niobium;
the plurality of elongated steel wire members being made from the steel rod material by drawing the steel rod material to form said steel wire members;
wherein the diameter of the cross-sectional area of the steel rod material is reduced by at least about 20% when the steel rod material is drawn to form the steel wire members;
the outer surface of the oven rack being coated by a glass material;
wherein the amount of carbon in the steel rod material, the amount of carbon stabilizing transition metal in the steel rod material and the degree to which the cross-sectional area of the steel rod material is reduced when the steel wire is drawn from the steel rod material are selected so as to prevent chipping of the glass material away from the outer surface of the steel wire members due to out-gassing of hydrogen gas from the steel wire, when the steel wire members are heated to a temperature above 900° F.

26. The coated steel wire oven rack of claim 25, wherein the glass material is porcelain.

27. The coated steel wire oven rack of claim 26, wherein the porcelain comprises porcelain enamel.

28. The coated steel wire oven rack of claim 26, wherein the porcelain coating has a thickness in the range of 4 to 10 mils.

29. A method of making a coated steel wire oven rack, comprising the steps of:
a) providing steel rod material containing from about 80 to about 99.9% by weight of iron, from about 0.001 to about 0.08% by weight of carbon and from about 0.001 to about 0.2% by weight of carbon stabilizing transition metal selected from the group consisting of Vanadium, Tantalum, Titanium and Niobium;
b) drawing the steel rod material to form steel wire, wherein the diameter of the cross-sectional area of the steel road material is reduced by at least about 20%;
c) forming a plurality of elongated steel wire members from said steel wire;
d) joining the plurality of steel wire members to one another to form interconnected parts of a steel wire oven rack; and
e) coating the steel wire oven rack with porcelain.

30. The method in accordance with claim 29, wherein the step of coating includes two separate electrostatic coating steps in which a first ground coat of powdered glass is applied and then a second top coat of powdered glass is applied in a subsequent electrostatic coating application.

31. The method of claim 29, wherein the porcelain is coated onto the steel wire oven rack in a wet coating process selected from the group consisting of wet spray, electrostatic wet spray, wet flow coating, wet dip, electrophoretic deposition, and a combination thereof, followed by heating to a temperature of about 1550° F. or higher.

32. The method of claim 29, wherein the porcelain is coated onto the steel wire oven rack by an immersion or flow coating method selected from the group consisting of hand dipping, tong dipping, automatic dip machine coating, electrophoretic deposition, flow coating, and a combination thereof, followed by heating to a temperature of about 1550° F. or higher.

33. The method of claim 31, wherein the porcelain coated steel wire oven rack is heated to 1550° F. or higher for about 25 minutes prior to cooling.

34. The method of claim 32, wherein the porcelain coated steel wire oven rack is heated to 1550° F. or higher for about 25 minutes prior to cooling.

35. The method of claim 29, wherein the steel rod is repeatedly drawn in a cold die to gradually reduce the diameter of the steel rod at least about 20%.

36. The method of claim 29, wherein the steel rod comprises 0.046% to 0.051% carbon; and 0.012% to 0.014% transition metal, and wherein the rod is reduced in diameter 31% to 53%.

37. The method of claim 36, wherein the steel wire has a diameter in the range of 0.192 inch to 0.259 inch.

38. The method of claim 29, wherein the steel rod further includes 0.34% to 0.36% Mn; 0.003% to 0.004% P; 0.004% to 0.005% S; 0.130% to 0.140% Si; and 0.100% to 0.120% Cu, by weight.

39. The method of claim 38, wherein the steel rod includes iron in an amount in the range of 99.329% to 99.342% by weight.

40. A method of cleaning a porcelain-coated steel wire oven rack capable of withstanding oven cleaning temperatures above 900° F. without porcelain chipping or cracking, comprising the steps of:
heating the oven to a temperature above 900° F., said oven containing said porcelain-coated steel wire oven rack formed by steps a)-e):
a) providing steel rod material containing from about 80 to about 99.9% by weight of iron, from about 0.001 to about 0.08% by weight of carbon and from about 0.001 to about 0.2% by weight of carbon stabilizing transition metal selected from the group consisting of Vanadium, Tantalum, Titanium and Niobium;
b) drawing the steel rod material to form steel wire, wherein the diameter of the cross-sectional area of the steel road material is reduced by at least about 20% to form cavities in the steel wire in which hydrogen, emitted from the steel wire, is received and compressed at the oven cleaning temperature, without chipping or cracking the porcelain coating;
c) forming a plurality of elongated steel wire members from said steel wire;
d) joining the plurality of steel wire members to one another to form interconnected parts of a steel wire oven rack; and
e) coating the steel wire oven rack with porcelain.
